(19) United States
(12) Patent Application Publication
(10) Pub. No.: US 2010/0253467 A1
(43) Pub. Date: Oct. 7, 2010

(54) THERMAL OVERLOAD RELAY DEVICE

(75) Inventors: Takeo KAMOSAKI, Konosu-shi (JP); Fumihiro MORISHITA, Konosu-shi (JP); Yukinari FURUHATA, Konosu-shi (JP)

Correspondence Address: ROSSI, KIMMS & McDOWELL LLP., 20609 Gordon Park Square, Suite 150, Ashburn, VA, 20147, US

(73) Assignee: FUJI ELECTRIC FA COMPONENTS & SYSTEMS CO., LTD., Tokyo (JP)

(21) Appl. No.: 12/749,378

(22) Filed: Mar. 29, 2010

(30) Foreign Application Priority Data
Mar. 27, 2009 (JP) 2009-079397

(51) Int. Cl. H01H 61/04

(52) U.S. Cl. 337/85

(57) ABSTRACT

A thermal overload relay device has a mechanism that allows the interphase pitch between connection lines to be readily changeable without using a jig or the like in the work for electrically connecting the thermal overload relay to different types of electromagnetic contactors, thereby reducing the maintenance cost. The mechanism comprises a connection line-holding structure disposed in a casing and holding the connection lines, while permitting the distances between the connection lines to be readily changeable between among at least two different interphase pitches.

### BACKGROUND

A thermal overload relay device is an electric device composed of an electromagnetic switch that connect electrically to an electric contactor, and interrupts an electric circuit between a power supply and a load upon occurrence of overcurrent, namely larger than a predetermined value in the electric current running through an electric motor or the like to prevent an electric load from damaging the motor.

A thermal overload relay can comprise, as described in Japanese Unexamined Patent Application Publication No. 2004-172122 for example, an actuator mechanism generating an actuation force by bending deformation caused by temperature rise of a main bimetal, an adjusting mechanism working in response to the actuation force from the actuator mechanism, a contact reversing mechanism performing changeover of a contact by operation of the adjusting mechanism, and a casing to contain the actuator mechanism, the adjusting mechanism, and the contact reversing mechanism.

FIG. 14A shows a thermal overload relay 52 series-connected to an electromagnetic contactor 51A. The thermal overload relay 52 has a plurality of connection lines, an R-phase connection line 53a, an S-phase connection line 53b, and a T-phase connection line 53c, which connect to a plurality of terminals, namely an R-phase terminal 54a, an S-phase terminal 54b, and a T-phase terminal 54c, of the electromagnetic contactor 51A. The connection lines project out from a casing 52a.

As shown in FIG. 14B, the connection lines 53a, 53b, and 53c have a predetermined interphase pitch C set by plastically deforming the tips of the connection lines using a jig (not shown) corresponding to the terminals 54a, 54b, and 54c of the electromagnetic contactor 51A.

When the thermal overload relay 52 is series-connected, as shown in FIG. 15A, to another type of electromagnetic contactor 51B with an interphase pitch between the terminals 55a, 55b, and 55c different from the pitch of the electromagnetic contactor 51A, the tips of the connection lines 53a, 53b, and 53c are again plastically deformed using the jig to change the interphase pitch to a predetermined value D. See FIG. 15B.

The interphase pitch between the connection lines 53a, 53b, and 53c of the conventional thermal overload relay is changed by plastic deformation using a jig every time the relay is electrically connected to different types of electromagnetic contactors 51A and 51B, causing a maintenance cost problem. Since it is not possible or feasible to change the position of the connection line 53b of the thermal overload relay 52, it is not possible or feasible to adjust the width dimension with the electromagnetic contactor 51B. This can occasionally result in an electromagnetic switch having a width dimension G larger than the width dimension F (G>F) of the electromagnetic switch that is combined with the electromagnetic contactor 51A.

There remains a need for a thermal overload relay device that can readily change the interphase pitch between connection lines without using a jig when the thermal overload relay is electrically connected to different types of electromagnetic contactors. The present disclosure addresses this need.

### SUMMARY

A thermal overload relay device includes an actuator mechanism, an adjusting mechanism, a contact reversing mechanism, a casing housing, a plurality of connection lines, and a connection line-holding structure. The actuator mechanism includes a main bimetal that generates an actuating force by bending deformation accompanied by temperature rise of the main bimetal. The adjusting mechanism works by an actuating force exerted by the actuating mechanism. The contact reversing mechanism changes over contacts by action of the adjusting mechanism. The casing houses the actuator mechanism, the adjusting mechanism, and the contact reversing mechanism. The connection lines project out of the casing for connecting to a plurality of terminals of an electromagnetic contactor. The connection line-holding structure is disposed in the casing and holds the connection lines spaced at an interphase pitch between the connection lines projecting out of the casing. The connection line-holding structure permits the interphase pitch between the connection lines to be changeable.

The casing can comprise a case housing the actuator mechanism, the adjusting mechanism, and the contact reversing mechanism, and a cover detachably attached on the case to close an opening of the case and provided with a connection line-passing part where the connection lines extend through. The connection line-holding structure is attached on the case in a side of the opening and comprises at least six holding parts that hold parts of the connection lines allowing change of the distance between the connection lines.

The connection line-holding structure can be fixed to a specific position in the case by coupling to an inside wall of the case, partition walls provided in the case, and an inner wall of the cover attached on the case.

The connection lines can be housed in the casing and each of the connection lines can have a bending portion that elastically deforms so that the interphase pitch of the connection lines is changeble.

### BRIEF DESCRIPTION OF THE DRAWINGS

FIG. 1 is an external view of a thermal overload relay.

FIG. 2 is a perspective view of the thermal overload relay in a condition of the cover removed.

FIG. 3 is a sectional view of the parts of the thermal overload relay.

FIG. 4 is a perspective view of an adjusting mechanism in contact with an adjusting dial.

FIG. 5A illustrates a contact reversing mechanism and a normally opened contact (a-contact) in the initial state.

FIG. 5B illustrates a contact reversing mechanism and a normally opened contact (a-contact) in the tripped state.

FIG. 6A illustrates a contact reversing mechanism and a normally closed contact (b-contact) in the initial state.

FIG. 6B illustrates a contact reversing mechanism and a normally closed contact (b-contact) in the tripped state.

FIG. 7 is an exploded perspective view of a casing of the thermal overload relay and a connection line-holding structure supported by the casing.

FIG. 8 is a perspective view of the parts of the connection line-holding structure.

FIG. 9 is a perspective view showing a backside configuration of the cover.

FIG. 10A illustrates a connection line-holding structure supporting a plurality of connection lines so that an interphase pitch equals a predetermined value C.

FIG. 10B illustrates a connection line-holding structure supporting a plurality of connection lines so that an interphase pitch equals a predetermined value D (D≠C).

FIG. 11A is a perspective view showing a plurality of connection lines supported by a connection line-holding structure with an interphase pitch of C.

FIG. 11B is an enlarged view of a part in FIG. 11A.

FIG. 12A is a perspective view showing a plurality of connection lines supported by a connection line-holding structure with an interphase pitch of D.

FIG. 12B is an enlarged view of a part in FIG. 12A.

FIG. 13A illustrates an electromagnetic contactor and a thermal overload relay connected to the electromagnetic contactor with a plurality of connection lines with an interphase pitch of C.

FIG. 13B illustrates another type of electromagnetic contactor and a thermal overload relay connected to the electromagnetic contactor with a plurality of connection lines with an interphase pitch of D.

FIG. 14A illustrates a conventional thermal overload relay connected to an electromagnetic contactor.

FIG. 14B is an enlarged view of a part in FIG. 14A.

FIG. 15A illustrates a conventional thermal overload relay connected to another type of electromagnetic contactor.

FIG. 15B is an enlarged view of a part in FIG. 15A.

### DETAILED DESCRIPTION

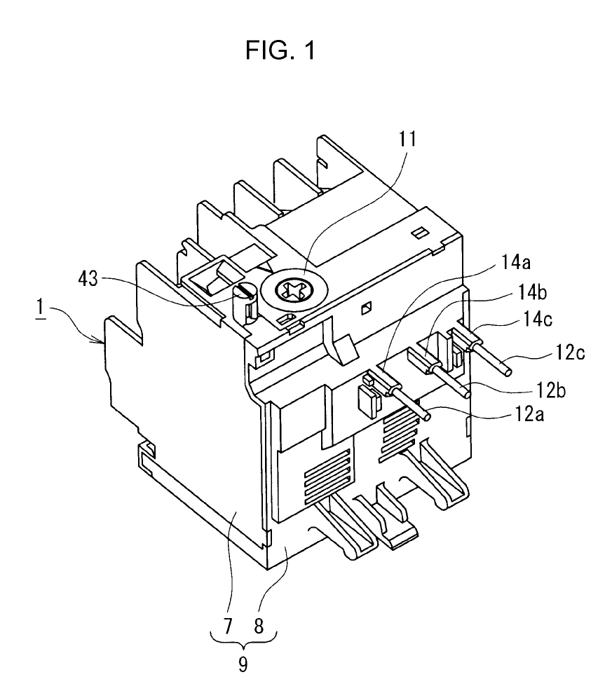

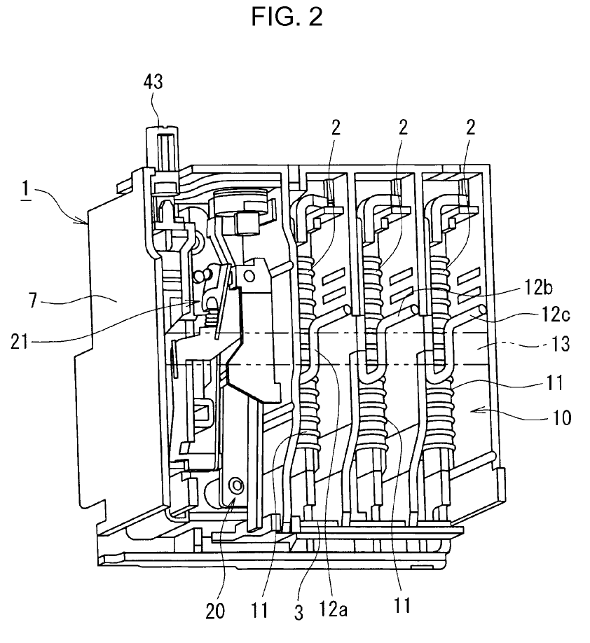

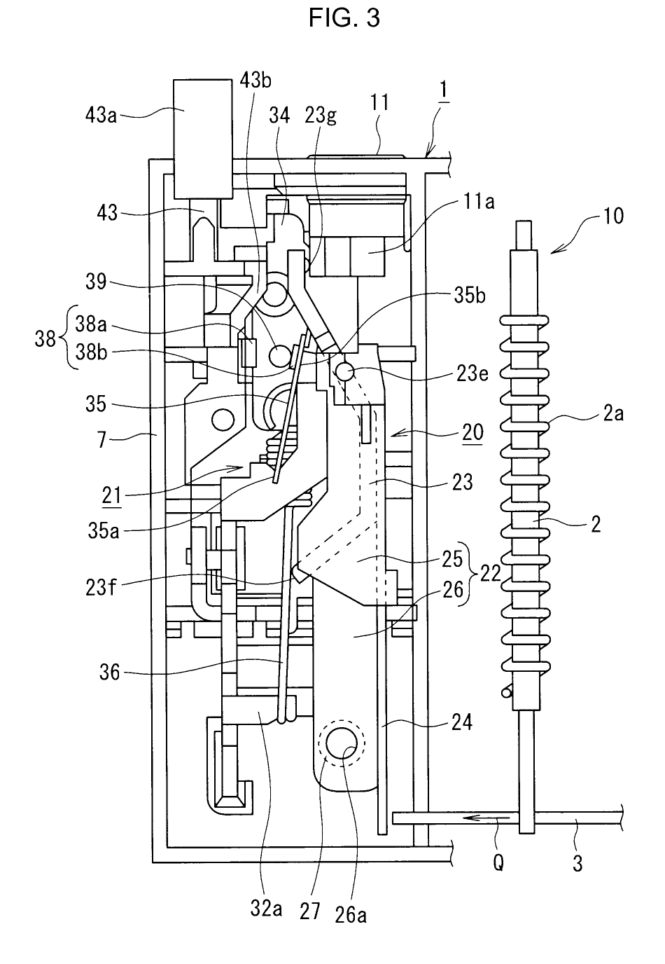

A thermal overload relay device of the embodiment shown in FIG. 1 comprises a casing 9 composed of an insulator case 7 and a cover 8 detachably attached to the insulator case 7. In the insulator case 7 are, as shown in FIGS. 2 and 3, an actuator mechanism 10 utilizing bending deformation of main bimetals 2 caused by temperature rise, an adjusting mechanism 20 working in response to displacement of a shifter 3 linked to an end of the main bimetal 2, a contact reversing mechanism 21 for changing-over contacts by the work of the adjusting mechanism 20, and a reset bar 43 for resetting the contact reversing mechanism 21.

The actuator mechanism 10 comprises a plurality of terminal blocks (not shown in the figures) that are electrically connected to the other ends of the three main bimetals 2 and electrically connecting to three power lines for R-phase, S-phase, and T-phase in the power supply side for supplying three phase alternating current, heaters 2a that are wound spirally around the outer circumferences of the main bimetals 2 and made of an electrically conductive wire generating heat corresponding to the current in the power lines in the power supply side, and the shifter 3 coupled to the one end of the three main bimetals 2.

Each end of the three connection lines 12a, 12b, and 12c is connected to the respective terminal block of the actuator mechanism 10. The three connection lines 12a, 12b, and 12c are formed by bending electrically conductive wires in a configuration of a crank, as shown in FIG. 2. The connection lines are supported by a connection line-holding structure 13 disposed in the side of the opening of the insulator case 7 in a configuration that allows the interphase pitch of the lines to be changed. The other ends of the connection lines for connecting to terminals of an electromagnetic contactor are, as shown in FIG. 1, projecting out of the casing 9 through connection line sleeves 14a, 14b, and 14c protruding from the cover 8. Each of the connection line sleeves 14a, 14b, and 14c has a hole with a configuration that allows movement of the connection lines 12a, 12b, and 12c running through the sleeves in the radial direction of the hole. The configuration of the hole can be an ellipse or a circular hollow with a diameter larger than outer diameter of the connection lines 12a, 12b, and 12c.

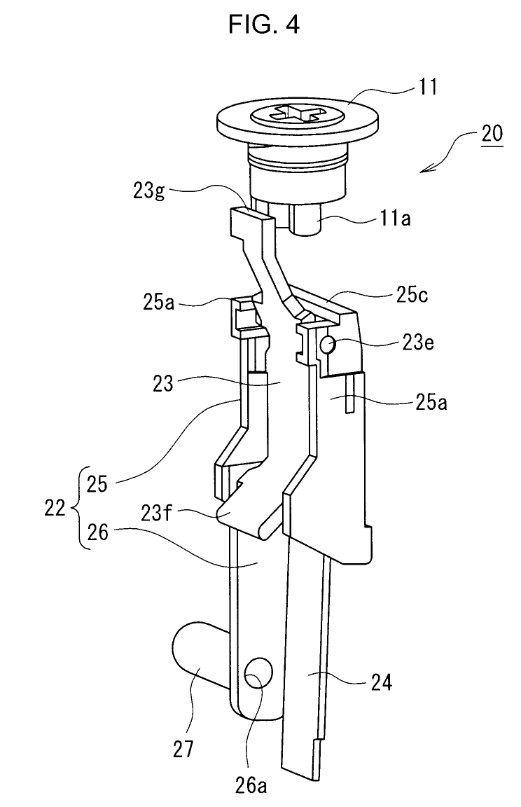

The adjusting mechanism 20 comprises, as shown in FIG. 3, an adjusting link 22, a release lever 23 rotatably supported by this adjusting link, and a temperature compensation bimetal 24 fixed to this release lever 23 and linked to the shifter 3. The adjusting link 22 is composed of a link support 25 supporting the release lever 23 and a leg part 26 extending downwards from one side of the link support 25. The link support 25 is provided, as shown in FIGS. 3 and 4, with a pair of opposing plates 25a having a bearing hole formed in the upper portion and opposing each other, and a connection plate 25c connecting the pair of opposing plates 25a. The leg part 26 extends downwards from one of the pair of opposing plate 25a with a bearing hole 26a formed in the lower portion thereof. A support shaft 27 protruding from the inner wall at the lower part of the insulator case 7 into inside of the insulator case 7. A tip of the support shaft 27 having a reduced diameter is inserted into the bearing hole 26a of the leg part 26 and the entire adjusting link 22 is supported rotatably around the support shaft 27 in the insulator case 7.

The upper portion of the release lever 23 has a pair of rotating shaft 23e to be inserted into a pair of bearing holes of the adjusting link 22. A reversing spring pushing part 23f is formed at the lower end of a portion of the release lever in the lower side than the rotating shaft 23e, and a cam contacting part 23g is formed in the upper side of the release lever 23. On the back surface of the release lever 23, an end of the temperature compensation bimetal 24 is fixed by caulking. The cam contacting part 23g of the release lever 23 is in contact with the circumferential surface of an eccentric cam 11a of the adjusting dial 11, which is disposed rotatably on the insulator case 7.

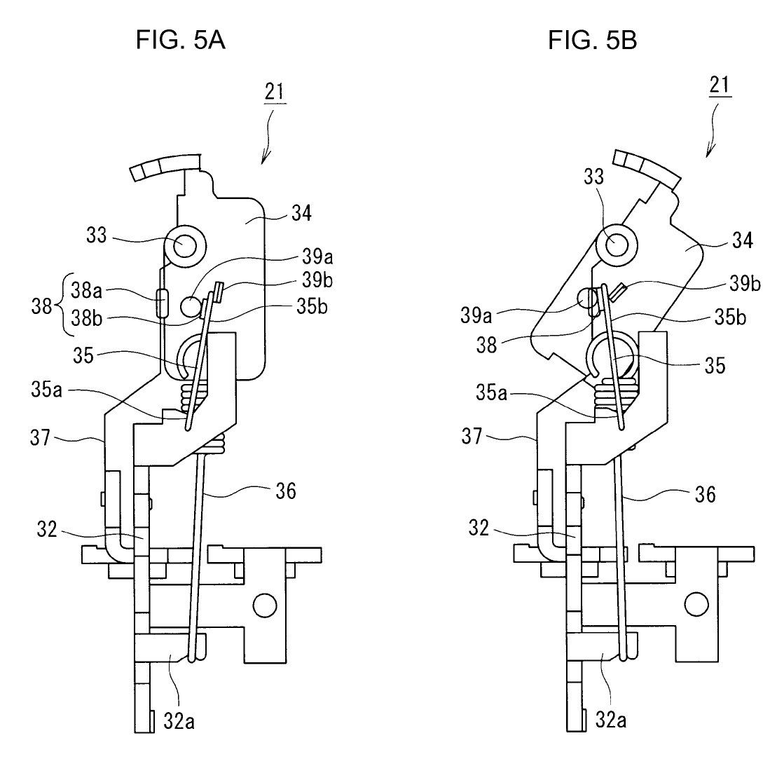

The contact reversing mechanism 21 comprises, as shown in FIG. 5A, a reversing mechanism support 32, an interlock plate 34 disposed in the vicinity of the reversing mechanism support 32 and rotatably supported on a support shaft 33 formed on the inner wall of the insulator case 7, a movable plate 35 with the upper portion 35b thereof disposed swingably around the lower portion 35a of the movable plate 35 abutting on the reversing mechanism support 32, and a reversing spring 36 that is a tension coil spring stretching between an engaging hole (not shown in the figure) formed in the side of the upper portion 35b of the movable plate 35 and a spring support 32a of the reversing mechanism support 32 positioned at a place lower than the lower part 35a of the movable plate 35.

The interlock plate 34 has a first linking pin 39a and a second linking pin 39b capable of linking to the movable plate 35, the first and second linking pins 39a and 39b making the interlock plate 34 to rotate around the support shaft 33 in the reversing operation and the returning operation of the movable plate 35. A leaf spring 37 of the normally opened contact (a-contact) side is fixed on the reversing mechanism support 32 in the configuration with the free end of the leaf spring 37 extending upwards. A fixed contact piece 38a of the a-contact is fixed on the free end side of the leaf spring 37. A movable contact piece 38b, which is to be made in contact with the fixed contact piece 38a, of the a-contact 38 is fixed on the upper portion 35b of the movable plate 35.

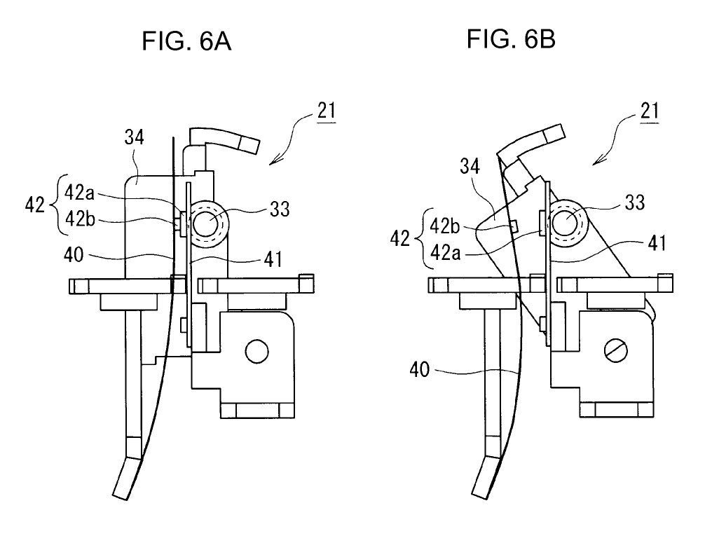

In the position opposite to the a-contact 38 with respect to the interlock plate 34, as shown in FIG. 6A, a leaf spring 40 of the normally closed contact (b-contact) side is disposed in the configuration with the free end of the leaf spring 40 extending upwards. A contact support plate 41 is disposed opposing the leaf spring 40. The free end of the leaf spring 40 links to a part of the interlock plate 34 and rotates together with the rotation of the interlock plate 34 in the same direction. A movable contact piece 42b of the b-contact 42 is fixed on the free end side of the leaf spring 40, and a fixed contact piece 42a, which is to be made in contact with the movable contact piece 42b, of the b-contact 42 is fixed to the contact support plate 41.

A reset bar 43 is provided, as shown in FIG. 3, with a reset button 43a being manually pushed into the insulator case 7 and a slope 43b for returning the movable plate 35, which is in a tripped state by touching with the a-contact side spring 37 shown in FIG. 5B, to the initial position (normal state).

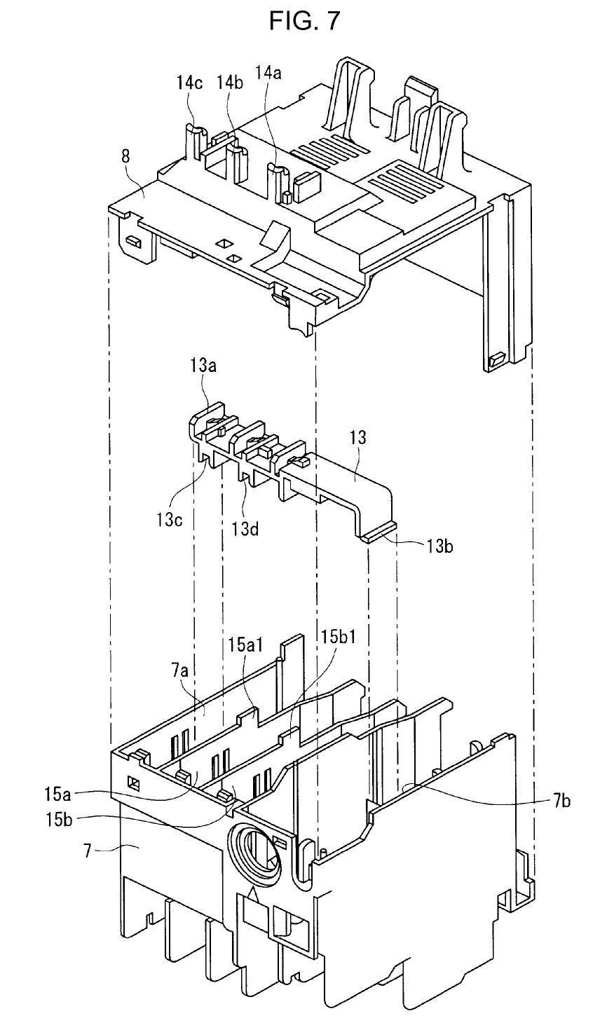

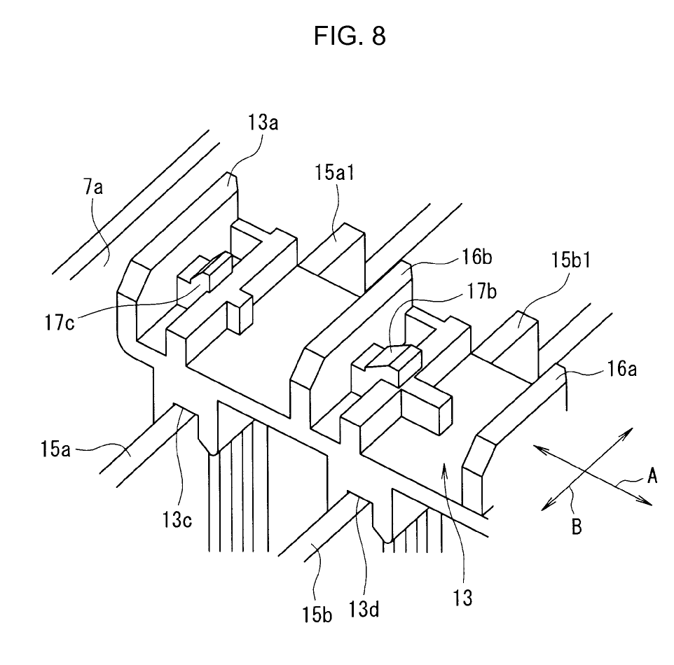

In the insulator case 7 composing the casing 9, as shown in FIG. 7, a plurality of partition walls 15a and 15b are provided in the direction along the pair of side walls 7a and 7b that are opposing to each other, for disposing the three main bimetals 2 of the actuator mechanism 10 into separated spaces. The connection line holding structure 13 is an elongated member made of an electrically insulative material for supporting the three connection lines 12a, 12b, and 12c, and, as shown in FIG. 7, an abutting wall 13a and an abutting piece 13b of the connection line holding structure 13 are linked to inner surface of a pair of side walls 7a and 7b. Coupling grooves 13c and 13d formed on the back surface side of the connection line holding structure 13 longitudinally separated from each other in the longitudinal direction (indicated by the symbol A in FIG. 8) are, as shown in FIG. 8, disposed with a configuration fitted to the open ends of the partition walls 15a and 15b in the insulator case 7.

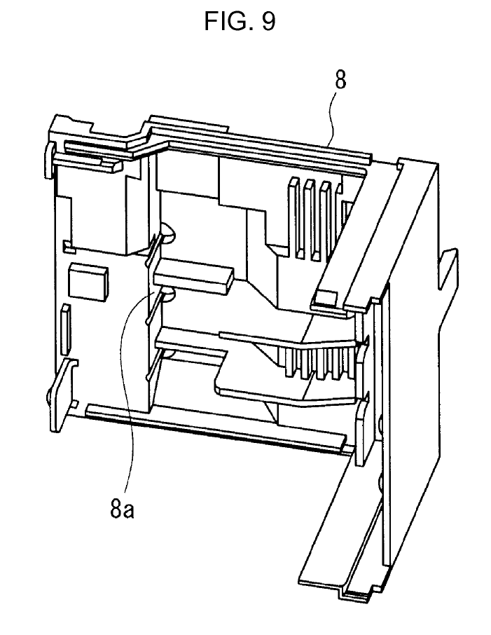

As shown in FIG. 8, the partition walls 15a and 15b have abutting protrusion parts 15a1 and 15b1 to abut on the end in the perpendicular direction (indicated by the symbol B in FIG. 8) of the connection line holding structure 13 disposed in the insulator case 7. On the inner surface side of the cover 8, as shown in FIG. 9, a abutting inside wall protrusion 8a is formed to abut on the other end in the perpendicular direction of the connection line holding structure 13 when the connection line holding structure 13 is placed in the insulator case 7 and the cover 8 is coupled with the insulator case 7.

Since the coupling grooves 13c and 13d of the connection line holding structure 13 fit to the open ends of the partition walls 15a and 15b, and one end in the perpendicular direction of the connection line holding structure 13 abuts on the abutting protrusion parts 15a1 and 15b1 and the other end in the perpendicular direction of the connection line holding structure 13 abuts on the abutting inside wall protrusion 8a, movement of the connection line holding structure 13 is obstructed both in the longitudinal direction and the perpendicular direction.

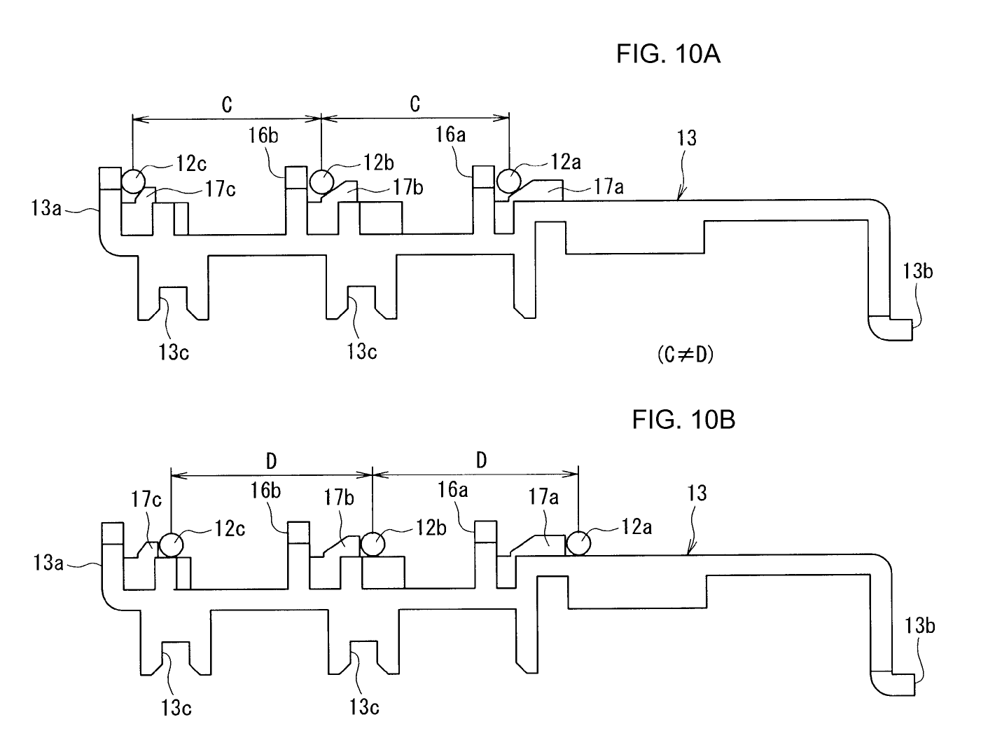

On the upper surface of the connection line holding structure 13, as shown in FIG. 10A, a pair of holding walls 16a and 16b are formed with a predetermined distance therebetween in the longitudinal direction. Further on the upper surface of the connection line holding structure 13, three holding protrusions, a first holding protrusion 17a, a second holding protrusion 17b, and a third holding protrusion 17c, are formed. The first holding protrusion 17a is formed at a side of the holding wall 16a opposing the abutting piece 13b, the second holding protrusion 17b is formed at a side of the holding wall 16b in a place between the holding wall 16a and the holding wall 16b, and the third holding protrusion 17c is formed in the close vicinity of the abutting wall 13a in the place between the abutting wall 13a and the holding wall 16b. The upper surface of each of the first, second and third holding protrusions 17a, 17b, and 17c has a slanting surface portion ascending from the side of the abutting wall 13a to the side of the abutting piece 13b.

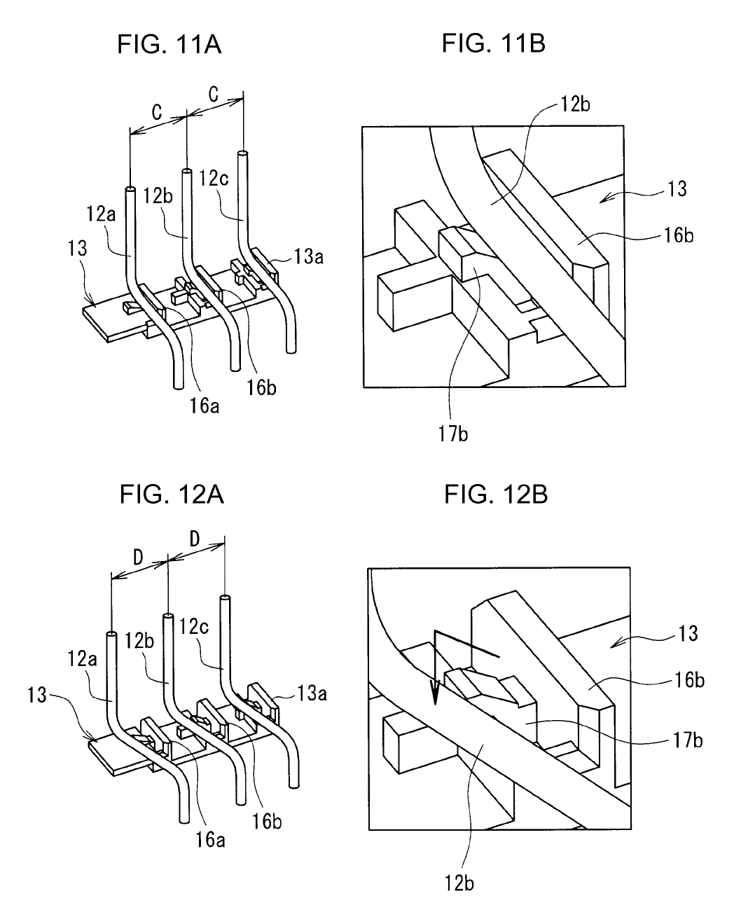

As shown in FIG. 10A, the connection line 12a is supported at the position touching to the holding wall 16a and the slanting surface portion of the first holding protrusion 17a, the connection line 12b is supported at the position touching to the holding wall 16b and the slanting surface portion of the second holding protrusion 17b, and the connection line 12c is supported at the position touching to the abutting wall 13a and the slanting surface portion of the third holding protrusion 17c. In this disposition, the three connection lines 12a, 12b, and 12c are supported on the connection line holding structure 13 with an interphase pitch set at a value C. The connection lines 12a, 12b, and 12c are supported, as shown in FIGS. 11A and 11B, at the portions thereof running on the connection line holding structure 13, the portions being sections of the connection lines just before passing through the connection line sleeves 14a, 14b, and 14c.

As shown in FIGS. 10B, 12A, and 12C, when the connection line 12a crosses over the first holding protrusion 17a and supported at the side opposing the abutting piece 13b, the connection line 12b crosses over the second holding protrusion 17b and supported at the side opposing the holding wall 16a, and the connection line 12c crosses over the third holding protrusion 17c and supported at the side opposing the holding wall 16b, the three connection lines 12a, 12b, and 12c are supported on the connection line holding structure 13 with an interphase pitch set at the value D, which is different from the value C.

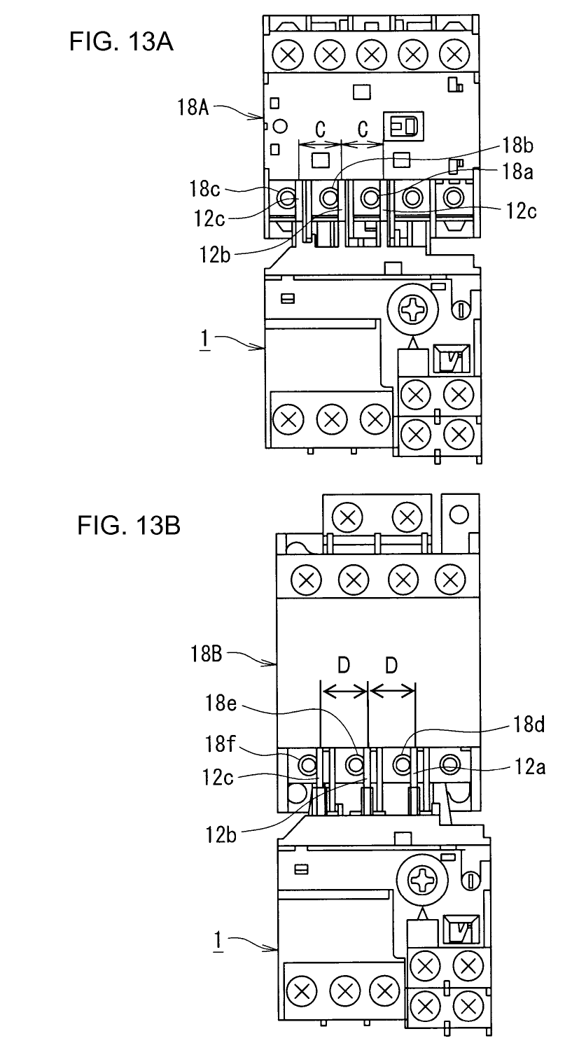

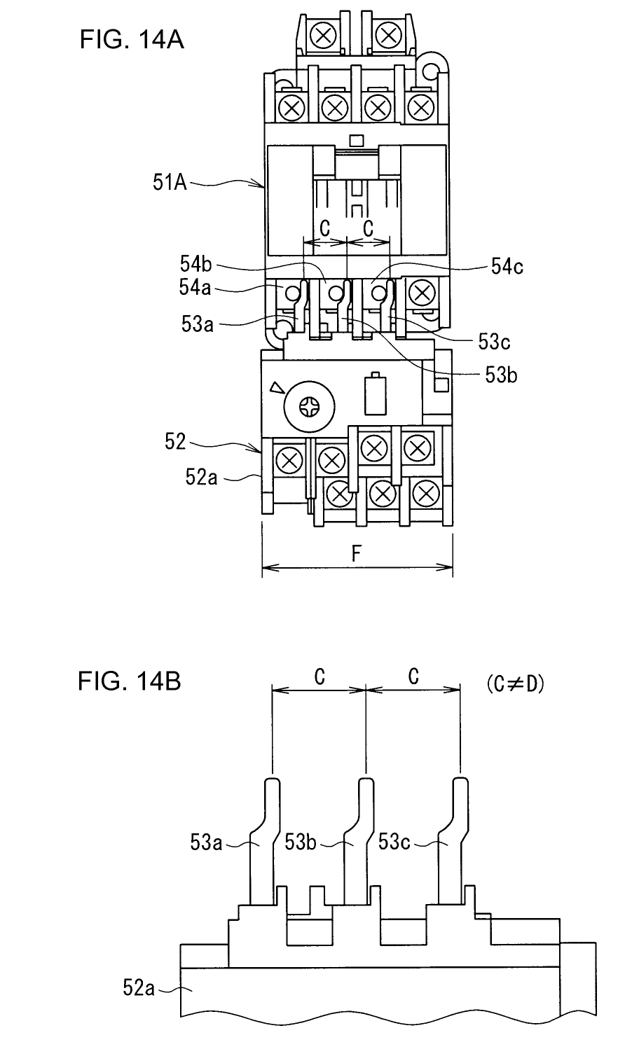

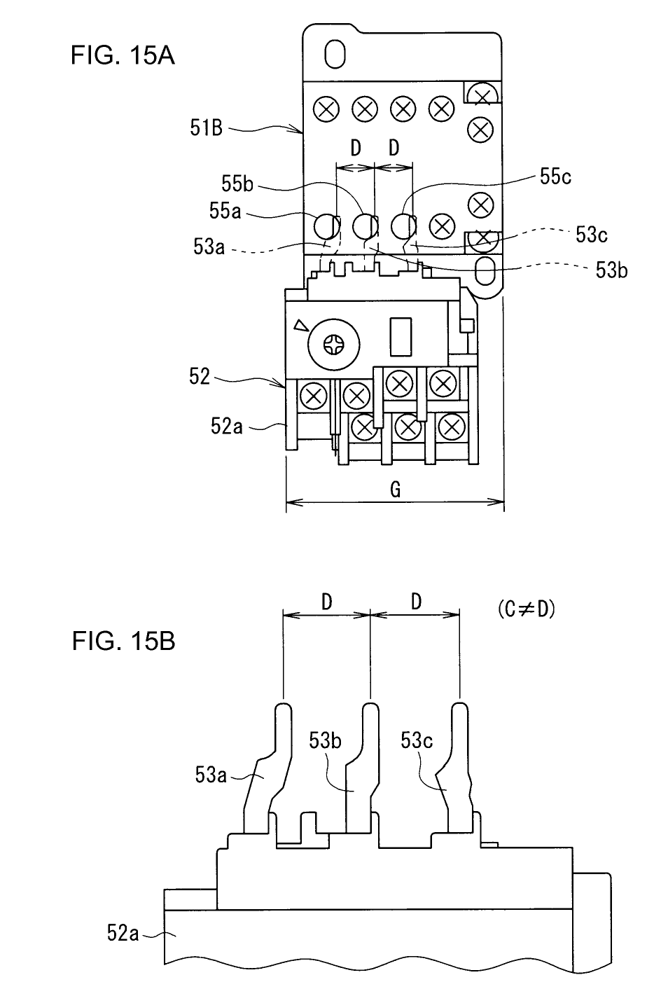

The following describes the thermal overload relay 1 of the foregoing embodiment connected in series to different types of electromagnetic contactors with reference to FIGS. 13A and 13B. A plurality of terminals, an R-phase terminal 18a, an S-phase terminal 18b, and a T-phase terminal 18c, of the electromagnetic contactor 18A shown in FIG. 13A are to be electrically connected to the thermal overload relay 1 having connection lines 12a, 12b, and 12c with an interphase pitch set at the value C.

After detaching the cover 8 of the thermal overload relay 1, the interphase pitch between the connection lines 12a, 12b, and 12c is set at the value C, as shown in FIGS. 10A, 11A, and 11B, by supporting the connection line 12a at the position touching the holding wall 16a of the connection line holding structure 13 and the slanting surface portion of the first holding protrusion 17a, supporting the connection line 12b at the position touching the holding wall 16b and the slanting portion of the second holding protrusion 17b, and supporting the connection line 12c at the position touching the abutting wall 13a and the third holding protrusion 17c. Then, after attaching the cover 8 on the case 7, the connection lines 12a, 12b and 12c projecting out through the connection line sleeves 14a, 14b, and 14c are electrically connected to the respective terminals 18a, 18b, and 18c of the electromagnetic contactor 18A.

To connect the thermal overload relay 1 to another type of electromagnetic contactor 18B having terminals, an R-phase terminal 18d, an S-phase terminal 18e, and a T-phase terminal 18f, with an interphase pitch D different from the pitch C of the electromagnetic contactor 18A, after detaching the cover 8 of the thermal overload relay 1, the interphase pitch between the connection lines 12a, 12b and 12c is set at the value D, as shown in FIGS. 10B, 12A, and 12B, by supporting the connection line 12a at the side of the first holding protrusion 17a of the connection line holding structure 13 crossed over the protrusion 17a and opposing abutting piece 13b, supporting the connection line 12b at the side of the second holding protrusion 17b crossed over the protrusion 17b and opposing the holding wall 16a, and supporting the connection line 12c at the side of the third holding protrusion 17c crossed over the protrusion 17c and opposing the holding wall 16b. After attaching the cover 8, the three connection lines 12a, 12b, and 12c projecting out through the connection line sleeves 14a, 14b, and 14c are electrically connected to the respective terminals 18d, 18e, and 18f of the electromagnetic contactor 18B.

Now, operation of the thermal overload relay 1 of the embodiment according to the invention will be described. Referring to FIG. 3, when the main bimetal 2 is bent by the heat generated by the heater 2a due to overcurrent, the displacement of the free end of the bimetal 2 displaces the shifter 3 in the direction of the arrow Q indicated in FIG. 3. When the displaced shifter 3 pushes the free end of the temperature compensation bimetal 24, the release lever 23 joined together with the temperature compensation bimetal 24 rotates around the rotating shaft 23d and 23e supported by the adjusting link 22 in the clockwise direction, and the reversing spring pushing part 23f of the release lever 23 pushes the reversing spring 36.

With progression of the clockwise rotation of the release lever 23, when the pushing force of the reversing spring pushing part 23f exceeds the spring force of the reversing spring 36, the movable plate 35 takes a reversing action around the lower portion 35a of the movable plate 35. The reversing action of the movable plate 35 makes the interlock plate 34, on which the reversing action of the movable plate 35 is transmitted through the first linking pin 39a, rotate around the support shaft 33, as shown in FIGS. 5B and 6B.

As a result, the fixed contact piece 38a and the movable contact piece 38b of the a-contact in the opened state shown in FIG. 5A are connected together, and the fixed contact piece 42a and the movable contact piece 42b of the b-contact 42 in the closed state as shown in FIG. 6A are separated away. Based on the information of the a-contact 38 and the b-contact 42, the electromagnetic contactor 18A or 18B is opened to interrupt the overcurrent in the main circuit.

When the reset button 43a is pushed-in in the condition of the main bimetal 2 returned to the original configuration from the bent state after interruption of the main circuit current, the slope 43b of the reset bar 43 exerts a resetting force through the a-contact side leaf spring 37 on the movable plate 35 in the tripped state shown in FIG. 5B, thereby returning the movable plate 35 to the position of initial state and at the same time, returning the interlock plate 34 to the position of initial state (normal state) through the second linking pin 39b. Thus, the thermal overload relay is reset.

The following describes effects of the thermal overload relay 1 of the embodiment according to the invention. An interphase pitch (C, D) between the three connection lines 12a, 12b, and 12c of the thermal overload relay 1 can be changed readily only by changing the coupling position of the connection lines 12a, 12b, and 12c to the connection line holding structure 13. Consequently, the conventional work for plastically deforming the tip of the connection line with a jig or the like is obviated, thereby reducing the maintenance cost.

Since the three connection lines 12a, 12b and 12c are bent in a configuration of a crank and extending allowing elastic deformation at least in the pitch direction, the interphase pitch between the three connection lines 12a, 12b, and 12c can be readily returned to the original interphase pitch (C to D or D to C). In addition, the position of the S-phase connection line can also be changed allowing adjustment of the width dimension between the electromagnetic contactors 18A and 18B. Therefore, an electromagnetic switch can have a reduced width dimension.

Change of the interphase pitch between the three connection lines 12a, 12b, and 12c can be performed using a connection line holding structure 13 attached in the side of an opening in the insulator case 7, the connection line holding structure 13 being only provided with the abutting wall 13a, a pair of holding walls 16a and 16b, and the first, second and third holding protrusions 17a, 17b, and 17c. Therefore, parts costs can be reduced.

Since the coupling grooves 13c and 13d of the connection line holding structure 13 fit to the open end of the partition walls 15a and 15b, and one end in the perpendicular direction of the connection line holding structure 13 abuts on the abutting protrusion parts 15a1 and 15b1 and the other end in the perpendicular direction of the connection line holding structure 13 abuts on the abutting inside wall protrusion 8a, movement of the connection line holding structure 13 is obstructed both in the longitudinal direction and the perpendicular direction. Consequently, the connection line holding structure 13 for setting the interphase pitch between the three connection lines 12a, 12b, and 12c can be attached to the casing 9 readily with high precision only by assembling the insulator case 7 and the cover 8 together.

In the embodiment described thus far, change of interphase pitch is performed between two interphase pitches C and D by the connection line holding structure 13 provided with the abutting wall 13a, a pair of holding walls 16a and 16b, and the first, second, and third holding protrusions 17a, 17b, and 17c. But the present invention also encompasses changing of the interphase pitch between the three connection lines 12a, 12b, and 12c between three or more interphase pitches by modifying the construction of the connection line holding structure 13.

According to the embodiment of the present invention, the connection lines can be elastically deformed freely in a direction of the pitch. Consequently, the interphase pitch of the connection lines can be readily returned to the original interphase pitch. To change the interphase pitch between the connection lines in a thermal overcurrent relay, the connection line-structure provides at least two selectable coupling locations for each of the connection lines to change the interphase pitch between the connection lines projecting out of the casing, obviating the work conventionally required for plastically deforming the tips of the connection lines by a jig or the like, thereby reducing the maintenance cost.

Assembling the case and the cover together is sufficient for attaching the connection line-holding structure to set the interphase pitch between the connection lines with high precision and ease.

While the present invention has been particularly shown and described with reference to particular embodiments, it will be understood by those skilled in the art that the foregoing and other changes in form and details can be made therein without departing from the spirit and scope of the present invention. All modifications and equivalents attainable by one versed in the art from the present disclosure within the scope and spirit of the present invention are to be included as further embodiments of the present invention. The scope of the present invention accordingly is to be defined as set forth in the appended claims.

This application is based on, and claims priority to, JP PA 2009-079397, filed on 27 Mar. 2009. The disclosure of the priority application, in its entirety, including the drawings, claims, and the specifications thereof, is incorporated herein by reference.

What is claimed is:

1. A thermal overload relay device comprising:
an actuator mechanism includes a main bimetal that generates an actuating force by bending deformation accompanied by temperature rise of the main bimetal;
an adjusting mechanism working by an actuating force exerted by the actuating mechanism;
a contact reversing mechanism changing-over contacts by action of the adjusting mechanism;
a casing housing the actuator mechanism, the adjusting mechanism, and the contact reversing mechanism;
a plurality of connection lines projecting out of the casing for connecting to a plurality of terminals of an electromagnetic contactor; and
a connection line-holding structure disposed in the casing and holding the connection lines spaced at an interphase pitch between the connection lines projecting out of the casing,
wherein the connection line-holding structure permits the interphase pitch between the connection lines to be changeable.

2. The thermal overload relay device according to claim 1, wherein:
the casing comprises a case housing the actuator mechanism, the adjusting mechanism, and the contact reversing mechanism, and a cover detachably attached on the case to close an opening of the case and provided with a connection line-passing part where the connection lines extend through; and
the connection line-holding structure is attached on the case in a side of the opening and comprises at least six holding parts that hold parts of the connection lines allowing change of the distance between the connection lines.

3. The thermal overload relay device according to claim 2, wherein the connection line-holding structure is fixed to a specific position in the case by coupling to an inside wall of the case, partition walls provided in the case, and an inner wall of the cover attached on the case.

4. The thermal overload relay device according to claim 1, wherein the connection lines are housed in the casing and each of the connection lines has a bending portion that elastically deforms so that the interphase pitch of the connection lines is changeble.

5. The thermal overload relay device according to claim 2, wherein the connection lines are housed in the casing and each of the connection lines has a bending portion that elastically deforms so that the interphase pitch of the connection lines is changeble.

6. The thermal overload relay device according to claim 3, wherein the connection lines are housed in the casing and each of the connection lines has a bending portion that elastically deforms so that the interphase pitch of the connection lines is changeble.
